(19) United States
(12) Patent Application Publication
(10) Pub. No.: US 2025/0276276 A1
(43) Pub. Date: Sep. 4, 2025

(54) Spontaneous Water Droplet Formation On Surfaces With Nanoscale Chemical And Topographical Heterogeneity

(71) Applicant: The Trustees of the University of Pennsylvania, Philadelphia, PA (US)

(72) Inventors: Baek Min Kim, Philadelphia, PA (US); Daeyeon Lee, Wynnwood, PA (US); Amish Jagdish Patel, Media, PA (US); Zachariah Thomas Vicars, Trainers, PA (US); Lilia Fernanda Escobedo, Philadelphia, PA (US); R. Bharath Venkatesh, Goleta, CA (US)

(21) Appl. No.: 19/069,653

(22) Filed: Mar. 4, 2025

Related U.S. Application Data
(60) Provisional application No. 63/560,989, filed on Mar. 4, 2024.

(51) Int. Cl. B01D 53/26; E03B 3/28

(52) U.S. Cl. CPC B01D 53/26; E03B 3/28; B01D 2257/80

(57) ABSTRACT

A heterostructured film configured to effect capillary condensation, the heterostructured film comprising: a bed of hydrophilic nanoparticles, the nanoparticles defining interstitial spaces therebetween; and a solidified hydrophobic polymer, the solidified hydrophobic polymer (i) bridging adjacent nanoparticles, (ii) partially filing some of the interstitial spaces between nanoparticles, or both (i) and (ii), and the heterostructured film having a porous surface that defines pores in fluid communication with at least some of the interstitial spaces. A method, comprising exposing a heterostructured film according to any aspect herein to an atmosphere under such conditions that water from the atmosphere isothermally forms droplets on the porous surface of the heterostructured film. A method, comprising: contacting a heterostructured film according to any aspect herein to an atmosphere so as to effect isothermal recovery of water from the atmosphere.

### CROSS-REFERENCE TO RELATED APPLICATIONS

This application claims benefit to U.S. Provisional Application No. 63/560,989, filed Mar. 4, 2024, the entirety of which application is incorporated by reference herein by reference for any and all purposes.

### GOVERNMENT RIGHTS

This invention was made with government support under 1933704 awarded by the National Science Foundation. The government has certain rights in the invention.

### TECHNICAL FIELD

The present disclosure relates to the field of composite materials.

### BACKGROUND

Condensation, the process by which a vapor transforms into a liquid as it loses energy, is a fundamental phenomenon pervasive in nature as well as various industrial processes including water collection and purification, power generation, and thermal management of electronic devices. Given its exothermic nature, conventional approaches for achieving condensation of undersaturated water vapor have necessitated the utilization of energy-intensive cooling methodologies.

Although a hydrophilic surface is more favorable for nucleation, a hydrophobic surface is more advantageous for inducing dropwise condensation, facilitating the continuous and cyclic progression of growth and departure of nucleated water droplets. Accordingly, a heat-conductive surface is often rendered hydrophobic through chemical modification or the introduction of surface roughness to facilitate water condensation and departure. Additionally, an ultra-smooth surface (i.e., a surface with extremely low contact angle hysteresis) implemented through deliberate manipulation of surface chemistry demonstrates enhanced mobility of water droplets.

A different mechanism that induces the condensation of water takes advantage of capillarity and surface tension forces. Porous materials such as packings of hydrophilic nanoparticles, metal-organic frameworks, and covalent-organic frameworks spontaneously collect liquid water via a process known as capillary condensation. When the condensate interacts favorably with the pore surface, the high negative curvature of the condensate liquid-vapor interface that can form in the nanoscale pore allows for capillary condensation to take place at vapor pressures below the saturation pressure of water. While these porous materials retain condensed water within the voids without cooling (i.e., energy duty=0), such water cannot be easily harvested or accessed and thus capillary condensation is not particularly well suited for applications that require water harvesting or macroscopic droplet formation. Accordingly, there is a long-felt need in the field for improved water harvesting approaches.

### SUMMARY

In meeting the described long-felt needs, the present disclosure provides a heterostructured film configured to effect capillary condensation, the heterostructured film comprising: a bed of hydrophilic nanoparticles, the nanoparticles defining interstitial spaces therebetween; and a solidified hydrophobic polymer, the solidified hydrophobic polymer (i) bridging adjacent nanoparticles, (ii) partially filing some of the interstitial spaces between nanoparticles, or both (i) and (ii), and the heterostructured film having a porous surface that defines pores in fluid communication with at least some of the interstitial spaces.

Also provided is a method, comprising exposing a heterostructured film according to any aspect herein to an atmosphere under such conditions that water from the atmosphere isothermally forms droplets on the porous surface of the heterostructured film.

Further provided is a method, comprising: contacting a heterostructured film according to any aspect herein to an atmosphere so as to effect isothermal recovery of water from the atmosphere.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIG. 1. Sketch of the macroscopic water droplet formation on the porous nanocomposite films. (A) Schematic illustration of the fabrication process of the porous nanocomposite films via the capillary rise infiltration (CaRI) technique. (B) Schematic illustration of how macroscopic water droplets form isothermally on the porous nanocomposite films at below saturation vapor pressure. The NP packing induces capillary condensation of water vapor into the interstitial voids at below saturation vapor pressure, and the water excessively condensed in the voids is spontaneously expelled towards out of the films. (C) Top-view optical microscope images of the isothermally formed macroscopic water droplets on a 370 nm thick PE-infiltrated SiO₂ NP (7 nm) film with ϕ_{PE} of 0.13 under 97% RH.

FIG. 2. Topographical and chemical heterogeneity of the nanoporous PE-infiltrated SiO₂ NP films. (A) Cross-sectional SEM images of the 250 nm thick nanoporous PE-infiltrated SiO₂ NP (22 nm) films as a function of ϕ_{PE}. As the value of ϕ_{PE} increases, the porosity of the films decreases. n indicates refractive indices of the films at the wavelength of 632.8 nm. (B) Caption about the simulation figure. (C) Water contact angle on the nanoporous PE-infiltrated SiO₂ NP films as a function of ϕ_{PE}. As the value of ϕ_{PE} increases, the water contact angle increases non-monotonically towards ≈100°, which is the value for a pure PE film. (D) Caption about the simulation figure.

FIG. 3. Capillary condensation in the nanoporous PE-infiltrated SiO₂ NP films. (A) Schematic illustration of capillary condensation of water vapor into the film. The amount of capillary condensate in the voids increases with RH (i). Here, the capillary condensate preferentially contacts PE, because the γ_{PE-water} is smaller than the γ_{air-water}. When the RH reaches a certain point, the voids become saturated with the capillary condensate (ii). At the RH above this point, the capillary condensate overflows (iii). (B) Changes in refractive indices of the PE-infiltrated SiO₂ NP (7 nm) films as a function of RH. Regardless of the ϕ_{PE} values, the refractive indices increase (i) and become saturated at ˜70% RH (ii), and beyond this point, they exceed the maximum values that the films can exhibit at a given thickness (iii). (C) Changes in the film thicknesses as a function of RH. (D) Changes in composition of the films excluding the water overlayer as a function of RH. (E) Proportion of the voids filled with the capillary condensate as a function of RH. (B) and (C) are obtained using the one-layer model, while (D) and (E) are obtained using the two-layer model that describes the films and water overlayers separately, in ellipsometric porosimetry.

FIG. 4. Observation of macroscopic water droplet formation on the nanoporous PE-infiltrated SiO₂ NP films. (A) Optical microscope images of the surfaces of the films with varying thicknesses. (B) Total volume of water droplets as a function of the film thickness. (C) Optical microscope images of the surfaces of the films with varying ϕ_{PE} values. (D) Number and volume of water droplets as a function of ϕ_{PE}. (E) Total volume of the water droplets on the films as a function of ϕ_{PE}. (F) Phase diagram of water droplet formation as a function of the NP size and RH. All measurements were performed 1 hr after exposure to the target humidity. All scale bars are 50 μm.

FIG. 5. Time evolution of the water droplets formed on the nanoporous PE-infiltrated SiO₂ NP films. (A) Optical microscope images of the surface of the film over time. The white arrows indicate two water droplets to coalescence. (B) Number and volume of water droplets as a function of time. (C) Total volume of water droplets as a function of time.

FIG. 6. Universality of spontaneous water droplet formation on the porous nanocomposite films. (A) Water contact angles on the porous nanocomposite films made of 7 nm-SiO₂ NP and other polymers (PS or PDMS) as a function of ϕ_{polymer}. (B) Optical microscope images of the surfaces of the porous nanocomposite films under 97% RH. The images were captured 1 hr after exposure to the target humidity. (C) Number, average size, and total volume of observed water droplets. For effective comparison, each of the values is normalized to the values obtained when using PE (FIGS. 4D and E).

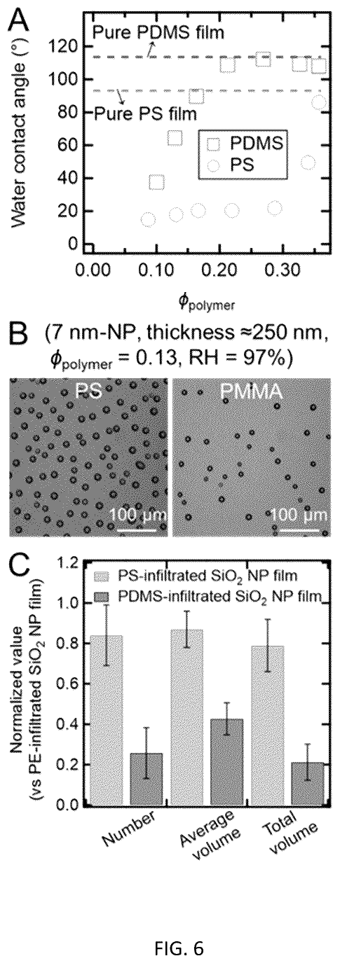

FIG. 7. Top-view SEM images of the porous PE-infiltrated SiO₂ NP (22 nm) films as a function of ϕ_{PE}. As the value of ϕ_{PE} increases, the porosity of the films decreases. n indicates refractive index of a film at the wavelength of 632.8 nm.

FIG. 8. Contact angle and the Young's equation (1) in the water-air-PE three phase system. (A) A side-view optical image of the water contact angle on a PE film. (B) A schematic illustration of the Young's equation. The γ_{PE-air} and γ_{air-water} are given as ≈34 and ≈72 mN/m in (2) and (3), respectively. Given the values, the γ_{PE-water} is estimated to be ≈50 mN/m.

FIG. 9. Macroscopic and microscopic water contact angles on a representative nanoporous PE-infiltrated SiO₂ NP film (NP size=7 nm, ϕ_{PE}=0.2, thickness ≈250 nm). (A) Side-view optical images of the placed macroscopic water droplet. (B) Side-view optical microscopy image of the water droplets exudated under ≈100% RH.

FIG. 10. PDMS contact angle on the SiO₂ NP surface. (A) Side-view optical images of the water contact angle on the Si wafer surface before and after surface modification. For the surface modification, the Si wafer is immersed in 0.1 M NaOH solution for 30 min and subsequent rinsing with DI water, maximizing the number of surface silanol groups like SiO₂ NP surfaces. (B) Side-view optical images of the PDMS contact angle on the surface modified Si wafer.

FIG. 11. Water harvesting using an alternating nanoporous PE-infiltrated SiO2 NP film/superhydrophobic surface. Nanoporous PE-infiltrated SiO2 NP film patches (7 nm-NP, ϕPE≈0.13, area ≈0.4 mm2, thickness ≈10 μm) are sparsely placed on a sanded Teflon sheet. The bumpy surface is then exposed to 97% RH, and after a week the condensed water on the patches (15 μL) is collected by light tapping.

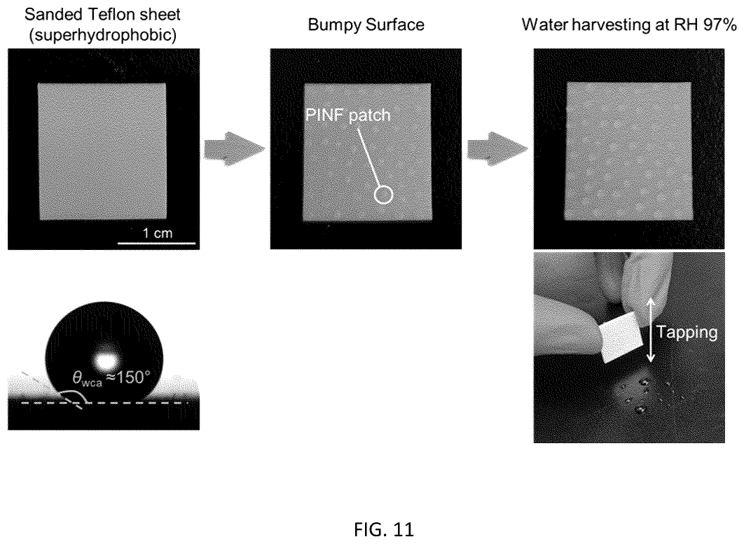

FIG. 12 provides a depiction of an exemplary embodiment of the disclosed technology.

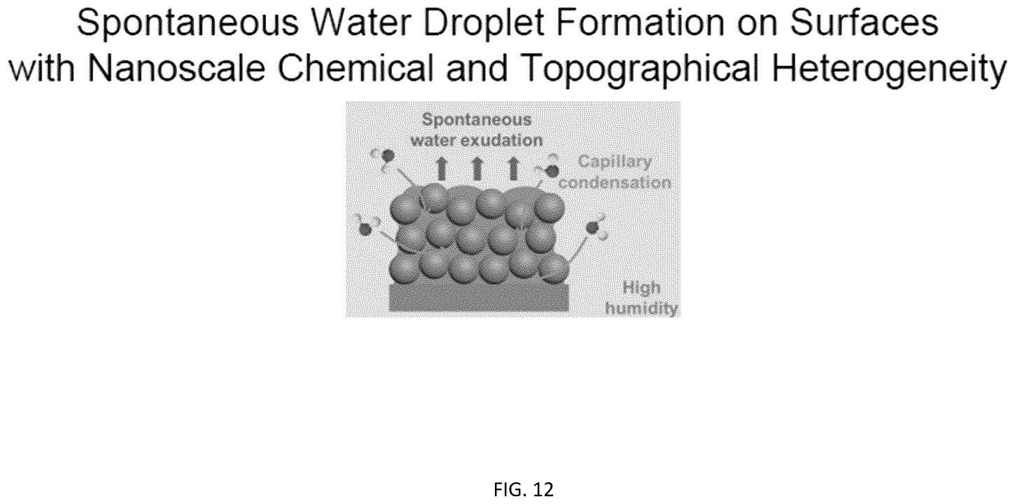

FIG. 13 provides a depiction of an exemplary embodiment of the disclosed technology.

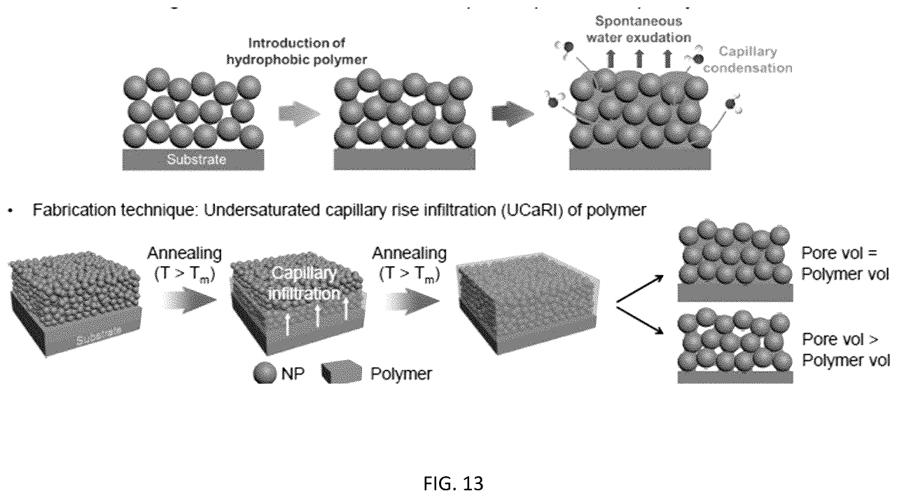

FIG. 14 provides exemplary materials and methods utilized in an example embodiment of the disclosed technology.

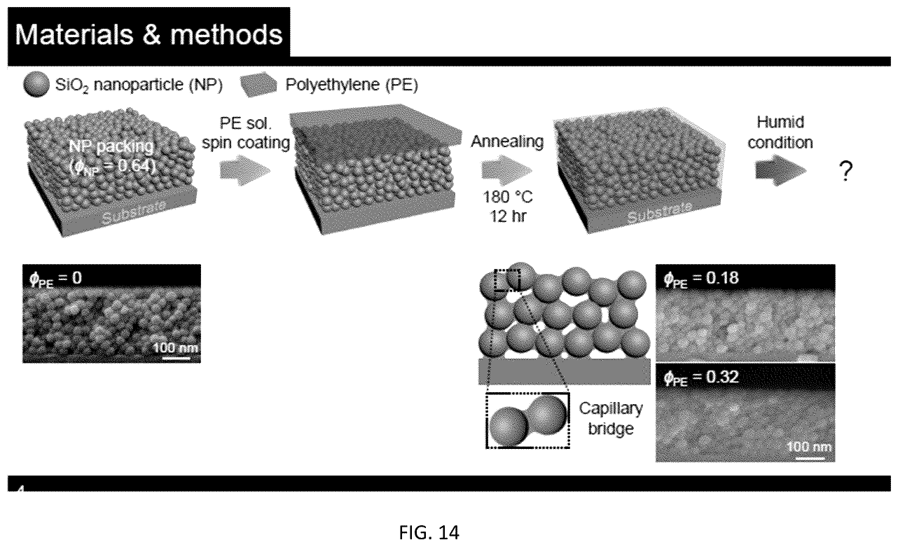

FIG. 15 provides a screenshot of a video of performance of an exemplary embodiment of the disclosed technology; as shown, macroscopic water droplets were observed as soon as the disclosed material was exposed to a humid environment.

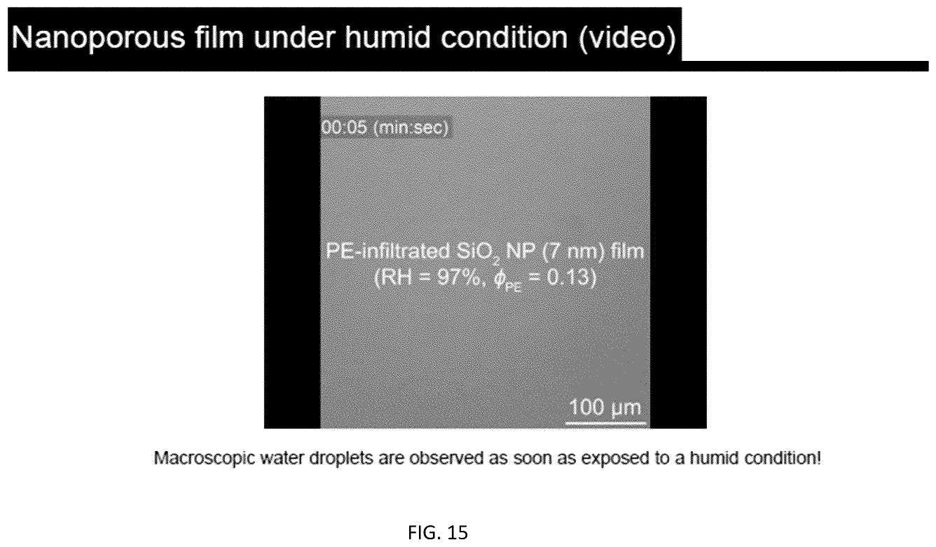

FIG. 16 provides example ellipsometric porosimetry results from an example embodiment of the disclosed technology.

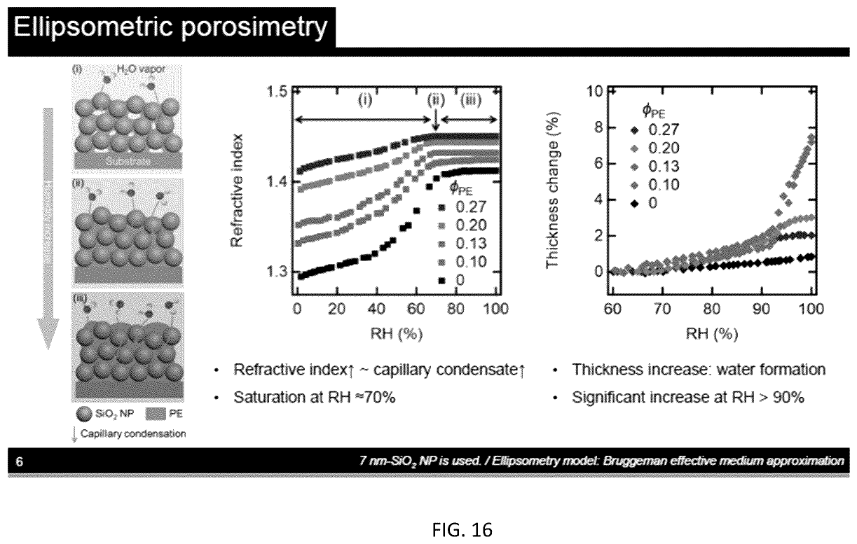

FIG. 17 provides an exemplary illustration of the film thickness effect observed with the disclosed technology.

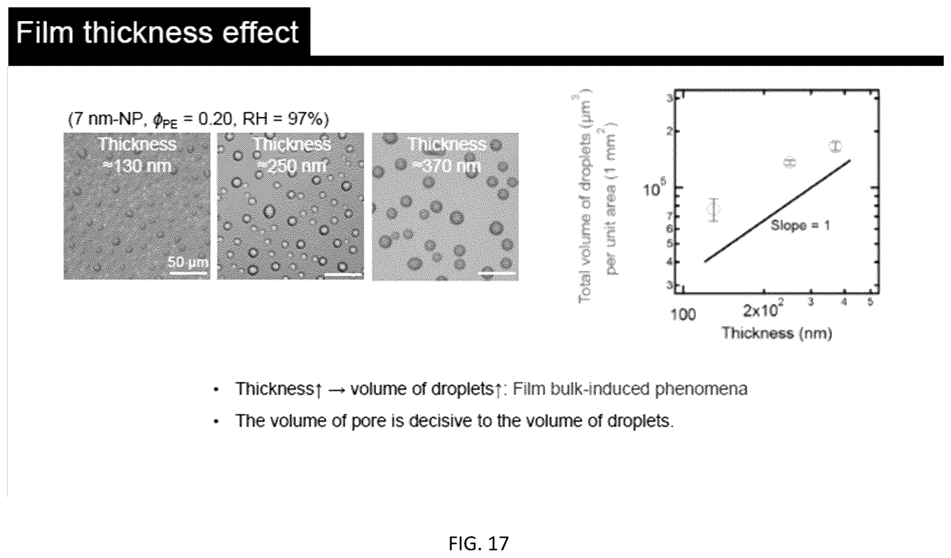

FIG. 18 illustrates the effect of changing the relative portion of polyethylene (PE) in an exemplary embodiment of the disclosed technology.

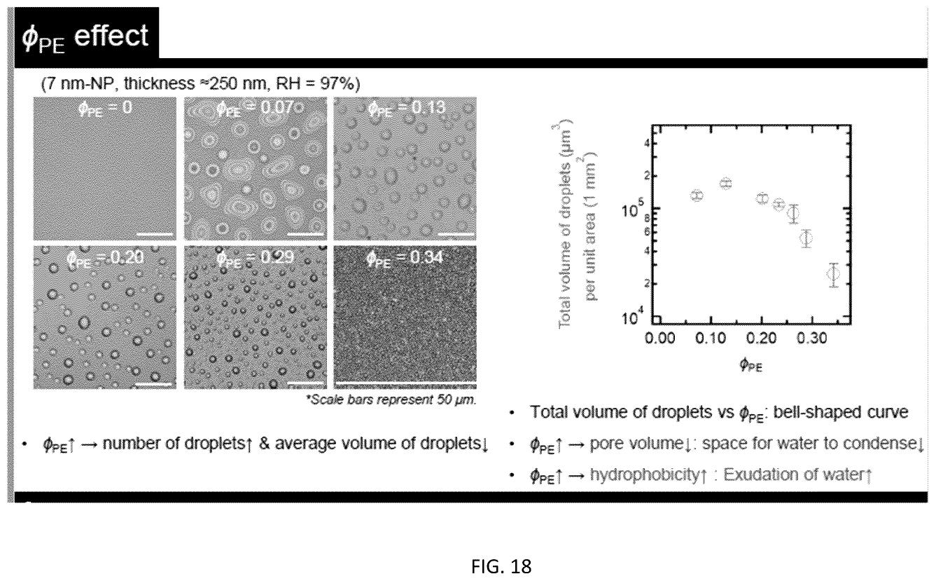

FIG. 19 illustrates the effects of varying nanoparticle size and relative humidity with material according to the present disclosure.

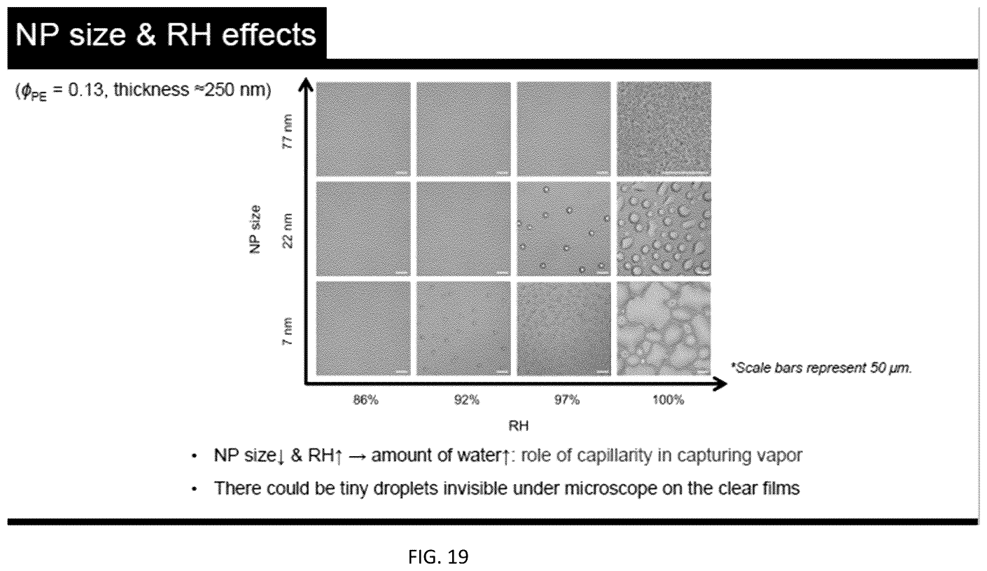

FIG. 20 provides images showing time evolution of water droplets evolved with a material according to the present disclosure.

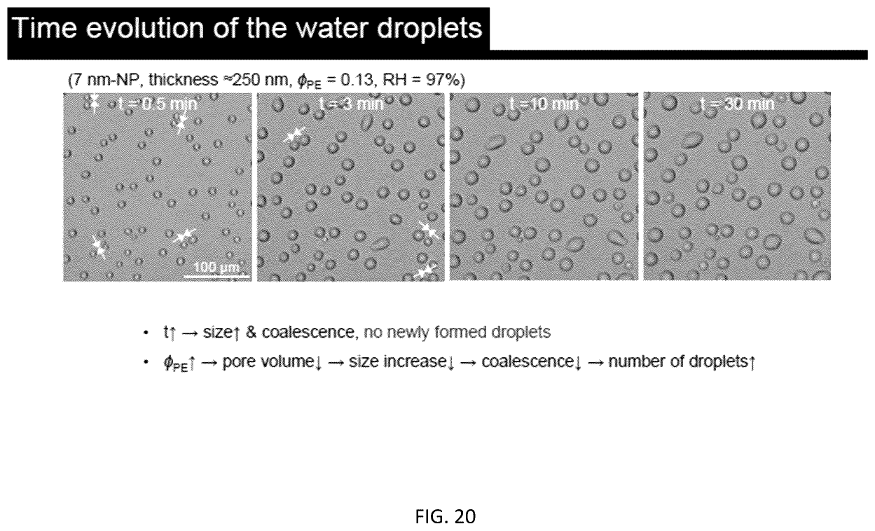

FIG. 21 provides exemplary water contact angle results for exemplary materials according to the present disclosure, at various levels of polyethylene.

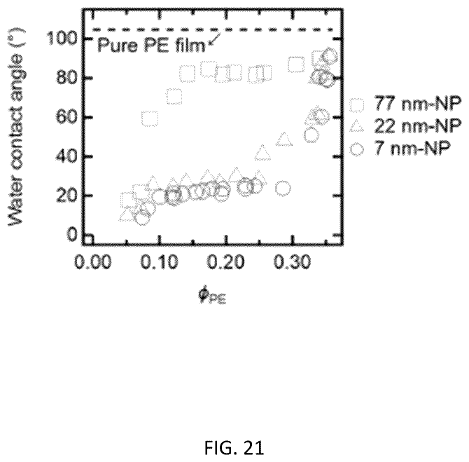

FIG. 22 provides exemplary, non-limiting depictions of the disclosed technology along with related, non-limiting commentary.

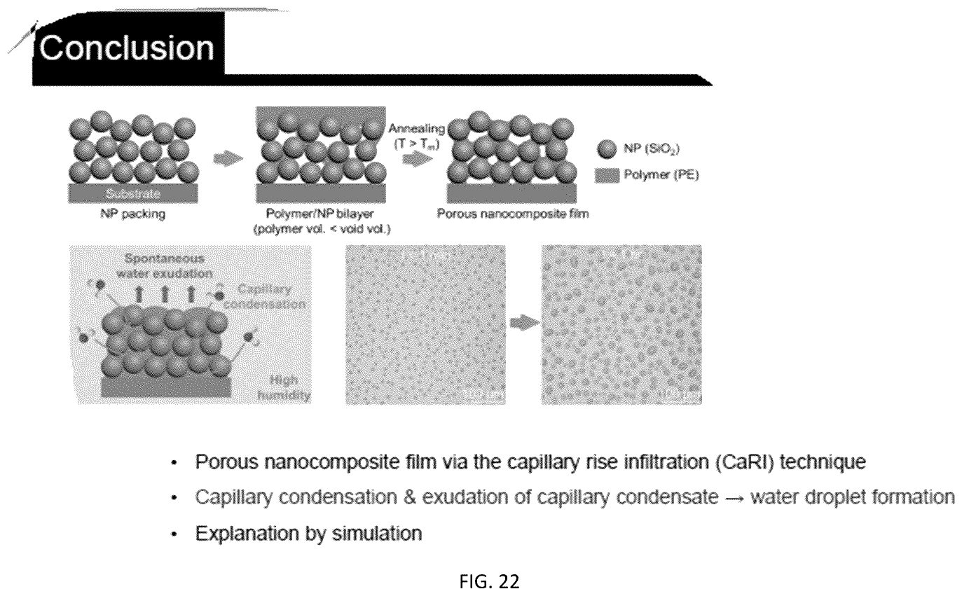

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated+10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4.

Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

Any embodiment or aspect provided herein is illustrative only and does not limit the scope of the present disclosure or the appended claims. Any part or parts of any one or more embodiments or aspects can be combined with any part or parts of any one or more other embodiments or aspects.

In this disclosure, we provide the isothermal formation of macroscopic water droplets on the surface of porous nanocomposite films featuring nanoscale chemical and topographical heterogeneity below saturation vapor pressure. These porous nanocomposite films are prepared by partially filling the interstices of randomly packed hydrophilic NPs with a hydrophobic polymer. Although this disclosure illustrates the technology with particular nanoparticle-polymer systems, it should be understood that these systems are illustrative only and do not limit the scope of the disclosed technology or the appended claims.

Through a combination of experimental and computational analyses, we demonstrate that as the vapor pressure increases, the voids are filled with capillary condensate. Without being bound to any particular theory or embodiment, beyond a specific vapor pressure, visible water droplets spontaneously form isothermally (i.e., without cooling) atop the film surface. The total volume of water droplets that form on the surface can depend on the volume fraction (ϕ) of polymer within the film and is inversely proportional to the NP size, illustrating the role of polymer hydrophobicity and capillary forces, respectively. In addition, the volume of water droplets is proportional to the thickness of the films at a constant ϕ_{polymer}, which implies that the droplet formation on the surface may be influenced more by the bulk structure of the film rather than that of the surface.

### Results & Discussion

Macroscopic Water Droplet Formation on Nanoporous Films with Chemical And Topological Heterogeneity

Nanoporous films with chemical and topological heterogeneity are prepared by infiltrating a hydrophobic polymer into the interstices of disordered packings of hydrophilic NPs. As an illustrative, non-limiting example, we select polyethylene (PE) and SiO₂ NPs, both of which are commonly available and used, as the hydrophobic polymer and hydrophilic NPs, respectively.

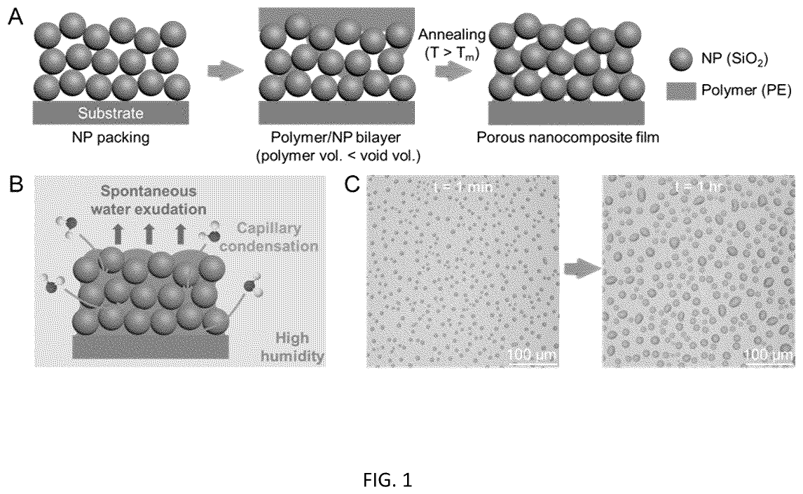

As depicted in FIG. 1A, a bilayer film composed of a PE layer atop a SiO₂ NP packing is heated above the melting temperature (Tₘ) of the PE so that the fluidized PE undergoes capillary rise infiltration (CaRI) into the interstitial voids of the NP packing; when the volume of PE is less than the void volume of the NP packing, a nanoporous PE-infiltrated SiO₂ NP film is obtained as the PE is distributed throughout the NP packing (28, 29). The volume fraction of NP (ϕ_{NP}) remains 0.64, whereas that of PE (ϕ_{PE}) can be varied from 0 to 0.36 by adjusting the volume of PE. The value of ϕ_{PE} after CaRI can be determined based on the refractive index (n) of the composite film composed of PE, SiO₂ NP, and void.

When exposed to high yet sub-saturating conditions (i.e., <100% relative humidity (RH)), macroscopic water droplets appear on the surfaces of the nanoporous PE-infiltrated SiO₂ NP films without the need to cool the surface as shown in FIG. 1B. FIG. 1C present the growth of macroscopic water droplets over time on the surface of a 370 nm thick nanoporous PE-infiltrated SiO₂ NP (7 nm) film with ϕ_{PE} of 0.13 RH=97%. Without being bound to any particular theory or embodiment, we believe that the driving force behind this intriguing spontaneous phenomenon is capillary condensation. When a molecule has favorable interactions with the surface of a nanoscale pore, the high negative curvature of the interface between its condensate and the vapor phase within the pore allows for condensation to occur at vapor pressures below its saturation pressure. Given the extremely high affinity of water to SiO₂ NP surfaces, the SiO₂ NP packings are a suitable system for capillary condensation of water vapor to occur. The infiltration of PE into the SiO₂ NP packing results in a nanoporous PE-infiltrated SiO₂ NP film with nanoscale surface heterogeneity; moreover, hydrophobic PE could occupy the most preferred site for capillary condensation between neighboring NPs. Limited understanding currently exists on how capillary condensation would occur in such porous media with nanoscale topographical and chemical heterogeneity.

### Topographical and Chemical Heterogeneity of the Porous Nanocomposite Films

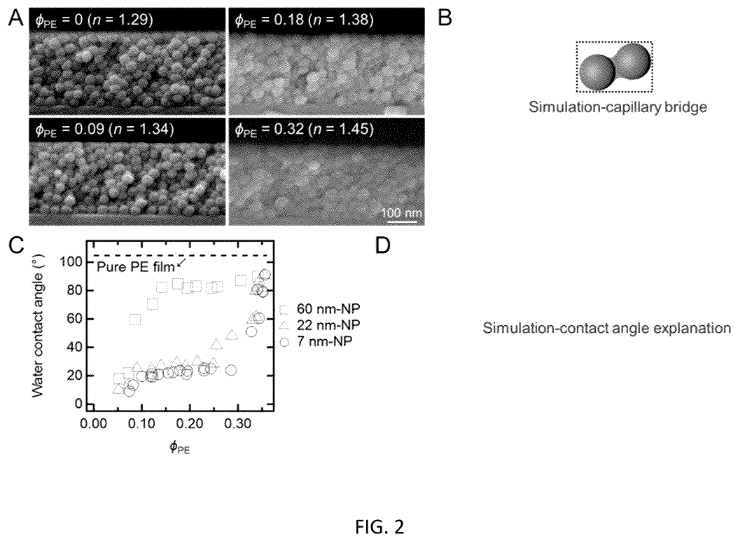

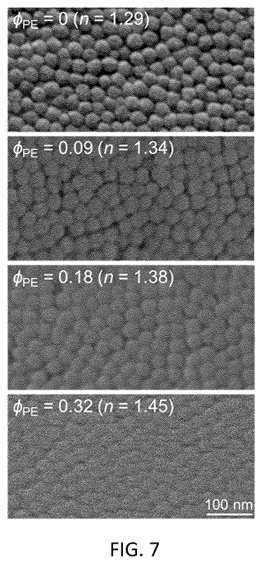

The nanostructures of the nanoporous PE-infiltrated SiO₂ NP films are visualized through scanning electron microscopy (SEM). FIG. 2A shows cross-sectional SEM images of a 250 nm thick packing of 22 nm-SiO₂ NPs with an increase in ϕ_{PE} (corresponding top-view SEM images can be found in FIG. 7). If the volume of the infiltrating polymer is smaller than that of the void in the nanoparticle packing, the polymer preferentially form capillary bridges between two adjacent NPs analogous to what would be expected when capillary condensation takes place in particle packings (28, 29, 34).

The topographical and chemical heterogeneity can affect the wettability of the film surface, which may in turn affect the water droplet formation. Although the water contact angle increases from ˜0° towards ˜100° ϕ_{PE} increased, which correspond to the values for a SiO₂ NP film and a neat PE film, respectively, the changes are not monotonic and differ according to the size of the NPs, as presented in FIG. 2C.

### Capillary Condensation in the Porous Nanocomposite Films

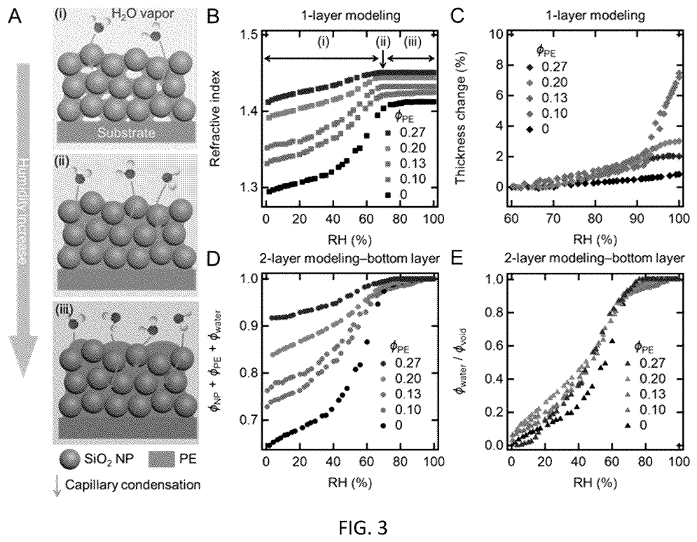

To investigate capillary condensation in the nanoporous PE-infiltrated SiO₂ NP films, we perform ellipsometric porosimetry and model the change in the films using a one-layer Bruggemean effective medium approximation for four components (water, void, PE and SiO₂). Regardless of the ϕ_{PE} values, the refractive indices of nanoporous PE-infiltrated SiO₂ NP (7 nm) films increase (i) and become saturated at ≈70% RH (ii) as the RH increases, as shown in FIG. 3B. The increase in the refractive index indicates an increase in the amount of condensed water (n=1.33) that fills the voids (n=1.00) via capillary condensation, as schematically illustrated in FIG. 3A. Intriguingly, at RH above 70% (iii, FIGS. 3A and B), the thickness of the films increases (remarkable at ≥90% RH) whereas that of the bare SiO₂ NP film remains almost unchanged, as presented in FIG. 3C. The increases in thickness suggest that there is a mass uptake even after the pores of the films have been saturated with water, possibly due to water build-up on the film surface (iii, FIG. 3A).

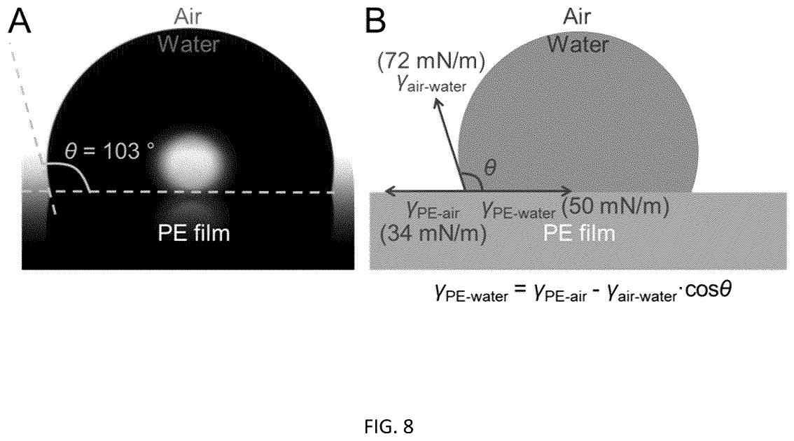

The apparent thickness increase based on the one-layer model, however, could be inaccurate because the water on the film surface may not be in the form of a thin film and/or the refractive index of water is different from that of the water-filled film. Hence, we use a two-layer model, where one is the same as described above and the other layer is a Cauchy layer, to model the change in the films and the overlayers, respectively. FIG. 3D presents the increase in the volume fraction of water (ϕ_{water}) in the films with given values ϕ_{PE} of and constant ϕ_{NP} (0.64) over RH. The slope of water capillary condensation over RH decreases as the value of ϕ_{PE} increases, however, when Øwater is normalized with the volume fraction of void (ϕ_{void}) (FIG. 3E), the slopes overlap well with each other. This implies that the extent to which the voids are filled with water remains relatively constant, and the increase in ϕ_{PE} is only associated with the decrease in Ovoid and does not significantly affect capillary condensation. We believe this negligible dependence of the extent of capillary condensation on ϕ_{PE} is due to two factors offsetting each other: (1) A greater surface coverage of NPs by PE suppresses capillary condensation; (2) the smaller interfacial energy between water and PE (γ_{PE-water}) than that between water and air (γ_{air-water}) (FIG. 8) facilitates capillary condensation.

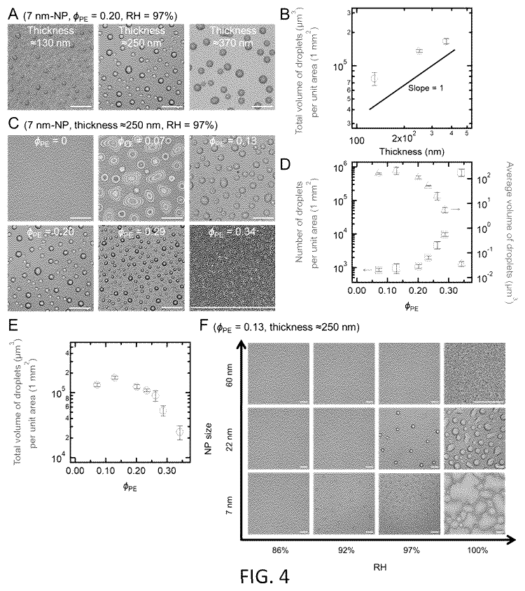

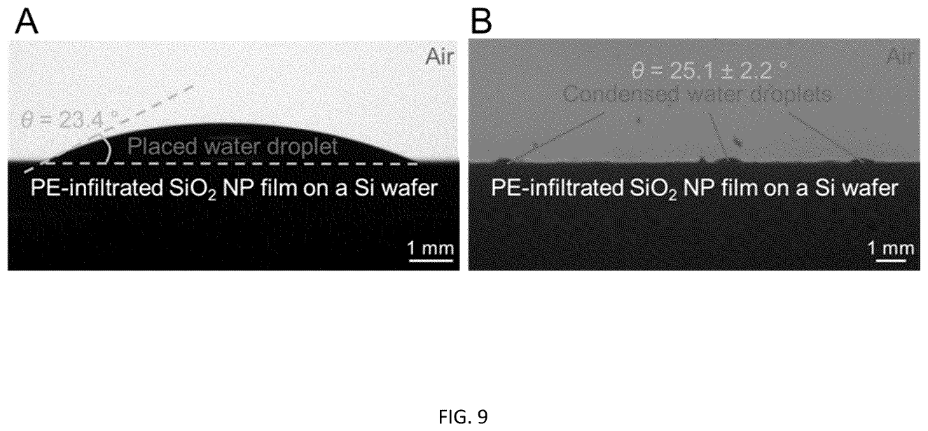

To confirm the presence of water on the films at high RH, we observe the surfaces using optical microscopy. Water indeed appears on the surfaces, and it is in the form of droplets rather than a film, as shown in FIG. 4A. The volume of a single droplet can be estimated using the contact angle and the radius of the droplet, assuming a spherical cap. We use the contact angle determined using macroscopic sessile droplets as reported in FIG. 2C. This value is consistent with the contact angle of microdroplets that form spontaneously at high RH (FIG. 9). An investigation into the relationship between film thickness and the volume of water droplets provides key insights into the origin of these droplets on the surface. As depicted in FIGS. 4A and B, we find that the total volume of the droplets increases linearly with the film thickness. This increase correlates with the volume of the nanopores inside the films. Such a trend suggests that the water droplets primarily emerge from the internal voids of the films, not directly from the surrounding vapor. Therefore, we believe that the droplets form through the seeping out of internal condensate, rather than by direct condensation on the surface.

### Factors Affecting Spontaneous Water Droplet Formation

In addition to the effect of film thickness, we observe two opposing trends as the ϕ_{PE} value increases: an increase in the number of droplets but a decrease in their average volume, as shown in FIGS. 4C and 4D. The relationship between the total volume of water droplets and ϕ_{PE} forms a bell-shaped curve (FIG. 4E), peaking at ϕ_{PE}=0.13. This peak indicates an optimal condition for achieving the maximum volume of water. The observed non-monotonic trend in the total volume of water droplets spontaneously forming on the film surface implies the presence of two conflicting factors. Without being bound to any particular theory or embodiment, one may hypothesize that the reduction in pore volume, limiting the space available for water to condense, is in balance with the increase in hydrophobicity of the pores, which promotes the exudation of water from the pores. Furthermore, the water droplets are only observed at RH above ≈90% for the films with NP size of 7 nm, as displayed in FIG. 4F, which we believe corresponds to the sharp increase of the film thickness at RH above ≈90% (FIG. 3C). We also believe that there may be tiny water droplets on the films invisible under an optical microscope in the RH range of 70-90%, where the film thickness gradually increases with RH (FIG. 3C). The amount of water overflow is strongly influenced by the size of NPs as well as the RH, as demonstrated in FIG. 4F, highlighting the role of capillarity in capturing water vapor.

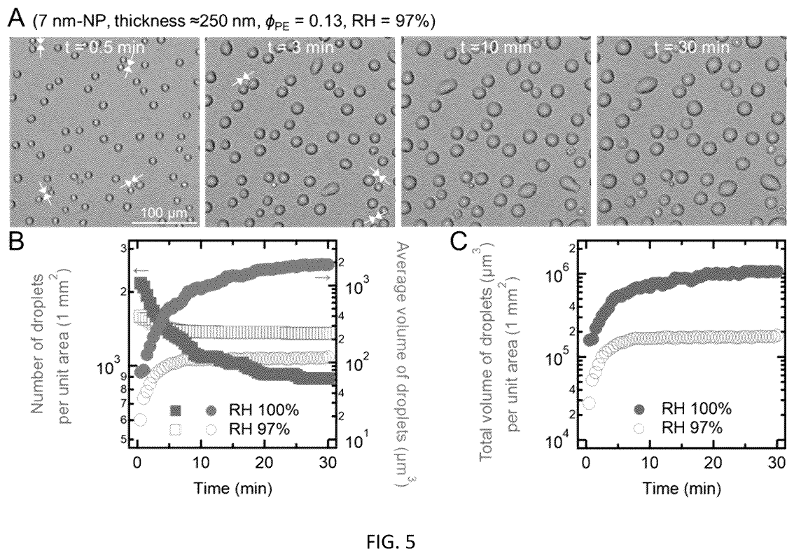

To understand the dual trend in the number of droplets and the size of each droplet (FIG. 4D), we study the time-dependent evolution of the water droplets as shown in FIG. 5A. Initial water droplets that are observable under optical microscopy (≈1 μm in size) appear within a few seconds after exposing a nanoporous PE-infiltrated SiO₂ NP (7 nm) film (ϕ_{PE}=0.13, thickness ≈250 nm) to 97% RH. We believe that these micrometer-sized droplets result from the growth and coalescence of numerous nanodroplets seeping out of nanovoids at the top surface of the film. Micrometer-sized droplets increase in size over time and some of them coalesce as indicated by white arrows (FIG. 5A). We do not observe any new droplets forming and growing after the first few seconds. We believe any nanoscopic droplets that may form on the surface disappear in the expense of increasing the size of already growing micrometer size droplets, akin to Oswald ripening. As a result, the number of droplets decreases, while their average and total volumes increase over time, as presented in FIGS. 5B and 5C. When the water droplets reach a certain size, the system reaches equilibrium, and these changes over time become less pronounced. As the volume of voids decreases with increasing ϕ_{PE}, the reduced amount of exuded water slows down the growth and coalescence of water droplets, which is intuitive in the ϕ_{PE} range of 0.1-0.3 exhibiting similar water contact angles (FIG. 2C). This explains the inverse relationship between the number and average volume of droplets presented in FIGS. 4C and 4D. The number, average volume, and total volume of the droplets as a function of time remain nearly constant after a certain point, and this point is delayed with increasing RH, as presented in FIGS. 5B and 5C.

### Universality of Spontaneous Water Droplet Formation

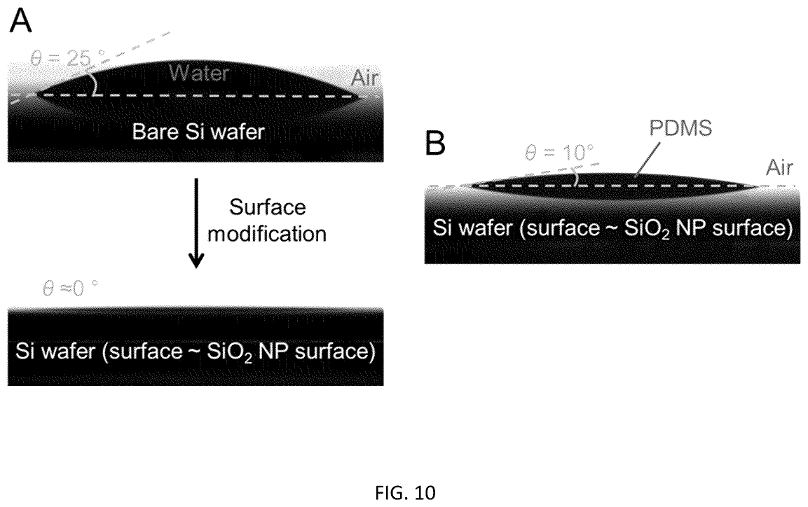

To demonstrate that the exudation of capillary condensate from the porous nanocomposite films does not depend on the inherent properties of PE, we test the feasibility of spontaneous water droplet formation when other common hydrophobic polymers, polystyrene (PS) and polydimethylsiloxane (PDMS), are used. The water contact angles on pure PS and PDMS films are comparable to that on a bare PE film (≈100)°, as presented in FIG. 7A. The contact angle of PS on SiO₂ surfaces is ≈20° (40), similar to that of PE, and accordingly, the water contact angles on the PS-infiltrated SiO₂ NP films as a function of ϕ_{PS} are also similar to those on the PE-infiltrated SiO₂ NP films (FIG. 7A). Likewise, we observe spontaneous formation of water droplets on nanoporous PS-infiltrated SiO₂ NP films with the overall trend mirroring that of the nanoporous PE-infiltrated SiO₂ NP films, as shown in FIGS. 7B and 7C. In contrast, when PDMS is used, the number, average size, and total volume of droplets significantly decreases (FIGS. 7B and 7C). Compared to the cases using PE and PS, PDMS likes SiO₂ surfaces more with a contact angle ≈10° (FIG. 10), and thus the bare area of the NP is smaller, leading to higher water contact angles on the PDMS-infiltrated SiO₂ NP films at the same ϕ_{PDMS} values. The smaller bare area of the NP yields weaker driving force for capillary condensation of water vapor, resulting in a smaller amount of water exudation.

### CONCLUSIONS

In this disclosure, we report that undersaturated vapor condenses isothermally to form macroscopic droplets on the surface of nanoporous PINFs prepared by partially filling the interstices of randomly packed hydrophilic NPs with a hydrophobic polymer. We have experimentally and computationally revealed that as the RH increases, the capillary condensate fills the voids completely and subsequently overflows in the form of droplets on the film surfaces. ϕ_{polymer} plays a crucial role in determining the amount of water droplets because an increase in the ϕ_{polymer} value facilitates the water expulsion while simultaneously corresponds to a decrease in the value of ϕ_{void}, and ϕ_{polymer} of ≈0.13 is found to yield the maximum amount. In addition, the amount of water droplets is proportional to the RH, and inversely proportional to the NP size, highlighting the importance of capillarity on driving this phenomenon.

### Experimental Section

### Materials

Monodisperse PE (Mₙ=78 000 g mol⁻¹, P2861-E) and PS (Mₙ=80 000 g mol⁻¹, P8500-S) were purchased from Polymer Source (Dorval, QC, Canada), and UV-curable PDMS (KER-4690 A and B) was purchased from Shin-Etsu Chemical Co., Ltd (Tokyo, Japan). For the SiO₂ NP aqueous dispersions with different NP sizes, Ludox SM-30 (7 nm) and TM-50 (22 nm) were obtained from MilliporeSigma (St. Louis, MO, USA), and Snowtex ST-YL (60 nm) was generously provided by Nissan Chemical America Corp. (Houston, TX, USA). Isopropyl alcohol (Certified ACS Plus), NaOH solution (1 N/Certified), decahydronaphthalene (99%), and toluene (HPLC Grade) were purchased from Fisher Scientific Co LLC (Pittsburgh, PA, USA). Potassium sulfate (ACS reagent, ≥99.0%), sodium carbonate (ACS reagent, anhydrous, ≥99.5%), potassium chloride (ACS reagent, 99.0-100.5%), and Rhodamine B (≥95%) were obtained from MilliporeSigma. Ethanol (200 Proof) was purchased from Decon Laboratories Inc (King of Prussia, PA, USA).

### Preparation of the Nanoporous PINFs

The stock SiO₂ NP aqueous dispersions were diluted with DI water (18.2 MΩ·cm) to ≈15 wt %, then the diluted dispersions were sonicated for at least 2 hr to ensure a homogeneous dispersion of the SiO₂ NPs, followed by filtration using hydrophilic syringe filters with a size cut-off of 0.45 μm (09-720-005, Fisher Scientific Co LLC) to remove potential NP agglomerates. PE was dissolved in decahydronaphthalene at 170° C. at a concentration range of 0.2-2.0 wt %. PS and UV-curable PDMS (a 1:1 mixture of the precursors A and B) were dissolved in toluene at concentration ranges of 0.2-2.0 wt % and 0.4-4.0 wt %, respectively.

A Si wafer (452, UniversityWafer, Inc., South Boston, MA, USA) was cleaved into ≈1.5×1.5 cm² pieces, then the surfaces of the cleaved Si wafers were rinsed with isopropyl alcohol and DI water, followed by oxygen plasma (PDC-32G, Harrick Plasma Inc., Ithaca, NY, USA) treatment for 5 min to eliminate any potential residual organic contaminants. SiO₂ NP packings with desired thicknesses were deposited onto the cleaved Si wafers by spin coating the prepared SiO₂ NP dispersions using a spin coater (WS-400BZ-6NPP/Lite, Laurell Technologies Corporation, North Wales, PA, USA). The spin coater was run for 1.5 min at 7000 rpm and 3000 rpm to achieve thicknesses of ≈130 nm and ≈250 nm, respectively, and thicknesses beyond these values were achieved with multiple coatings in succession. Polymer layers with desired thicknesses were then coated on top of the SiO₂ NP films by spin coating the prepared polymer solutions at 5000-7000 rpm for 30 sec. The PE-SiO₂ NP bilayer films and PS-SiO₂ NP bilayer films were annealed in a vacuum oven (Model 281A, Fisher Scientific Co LLC) at 180° C. for 12 hr to induce the infiltration of the polymers into the interstices of the SiO₂ NP layers via CaRI. The UV-curable PDMS layers spontaneously infiltrated into the interstices of the SiO₂ NP layers via CaRI during and after spin coating. The UV-curable PDMS-infiltrated SiO₂ NP films were exposed to UV light (illuminance ≈100 mW/cm², wavelength=365 nm) for 30 sec and then aged for 24 hr, to allow for full curing of the PDMS.

### Film Characterization

### Porosiometry

The thickness and refractive index of films are determined using a spectroscopic ellipsometer (SE-2000, Semilab, Budapest, Hungary). The ellipsometer measures parameters Ψ and Δ, which correspond respectively, to the amplitude ratio and the phase difference of the complex reflection coefficients of light polarized parallel and perpendicular to the plane of incidence. The measurements are carried out at 75° of incidence angle in the photon energy range of 1.3-4.5 eV, and the measured optical data are analyzed by the SEA software to extract the thicknesses and refractive indices. Each transparent layer is modelled as a Cauchy layer, and the refractive index is represented by n=A+B/λ²+C/λ⁴, where A, B, and C are optical constants and λ is wavelength of light. Modelling is performed with a small mean square error (<5). The relative humidity (RH) of the air surrounding the films is controlled using a humidity chamber (operated by a mass flow controller to ensure the ratio of dry and wet air inlet) compatible with the ellipsometer. For measurements in increased RH environments, the initial spectra are recorded at 40% RH, which is followed by an increase to a set RH value which is then kept constant in time.

Environmental ellipsometric porosimetry measurements are carried out in the same humidity chamber by recording ellipsometric spectra stepwise at increasing/decreasing RH (in the RH range between 2%-100%-2%). Lorentz-Lorenz effective medium approximation (EMA) is used to model the refractive index of the SiO₂ NP packings partially filled with air and adsorptive (water) molecules to obtain the volume adsorbed/desorbed isotherms from the fitted refractive index values. Porosity is calculated using the Lorentz-Lorenz EMA for the water filled SiO₂ NP packings at 100% RH, and the pore size distribution is obtained via the modified Kelvin-equation.

The microstructure of the films was visualized using a high-resolution SEM (JSM-7500F, JEOL Ltd., Tokyo, Japan). Prior to analysis, the films were coated with 4 nm Ir layers using a sputter coater (Q150TES, Quorum Technologies Ltd., Lewes, UK) to prevent possible charging. The SEM was operated under conditions of 5 kV electron beam voltage and 20 μA emission current. To confirm the interconnectivity of the voids, the transport of a dye (Rhodamine B)-incorporating ethanol solution within the films was monitored using an upright fluorescent microscope (Axioplan 2, Zeiss, Oberkochen, Germany) mounted with a CCD camera (MU1400B, AmScope) and mercury lamp (HBO 100, Zeiss) in the reflection mode. Contact angles were determined using a goniometer (Attension, Biolin Scientific, Gothenburg, Sweden).

AWH from Water Vapor Using the Nanoporous PINFs

To expose the nanoporous PINFs to the desired RH, the films were placed in a custom polycarbonate chamber fabricated using a 3D printer (ProJet 6000 HD, 3D Systems, Rock Hill, SC, USA), and the chamber was filled with various saturated salt solutions and then sealed with a high vacuum grease (DC976, Dow Corning Corp., Midland, MI, USA); the water vapor pressure in equilibrium over saturated salt solutions is lower than that over pure DI water, and depends on the type of salts. Potassium chloride, sodium carbonate, potassium sulfate aqueous solutions, and DI water were selected to achieve 86%, 92%, 97% and 100% RH, respectively. The top-view images of the condensed water droplets on the films were observed utilizing an upright optical microscope (Euromex, Arnhem, Netherlands) mounted with a CCD camera (MU800, AmScope, Irvine, CA, USA) in the reflection mode. The side-view image was obtained using a custom optical microscope in the transmission mode.

The alternating nanoporous PINF-superhydrophobic surface mimicking the body of Namib beetle was fabricated by introducing nanoporous PINFs in the form of patches on a superhydrophobic surface. To prepare a superhydrophobic surface, a hydrophobic Teflon sheet was sanded using an electro coated abrasive paper (grit 400, Lanhu, Beijing, China); the given roughness led the surface to the Cassie-Baxter state. The stock SiO₂ NP aqueous dispersions (Ludox SM-30) was diluted with DI water and ethanol to 0.5 vol. % (ratio of DI water to ethanol=8:2), and then the diluted dispersion was treated in the same manner as described above. The prepared dispersion was sparsely deposited on the superhydrophobic surface by pipetting with a volume of 0.5 μL. After the deposited dispersions are completely dry, a PE layer with a desired thickness was coated on the superhydrophobic surface with SiO₂ NP patches by spin coating 4 wt % PE solution in 170° C. decahydronaphthalene at 5000 rpm for 30 sec. The resulting film was annealed in the same manner as described above.

Additional information related to heterostructured films is be found in U.S. patent application Ser. No. 18/051,624, the entirety of which application is incorporated herein by reference for any and all purposes.

### Aspects

The following aspects are illustrative only and do not limit the scope of the present disclosure or the appended claims. Any part or parts of any one or more aspects can be combined with any part or parts of any one or more other aspects.

In one aspect, the present disclosure provides a heterostructured film configured to effect capillary condensation, the heterostructured film comprising: a bed of hydrophilic nanoparticles, the nanoparticles defining interstitial spaces therebetween; and a solidified hydrophobic polymer, the solidified hydrophobic polymer (i) bridging adjacent nanoparticles, (ii) partially filing some of the interstitial spaces between nanoparticles, or both (i) and (ii), and the heterostructured film having a porous surface that defines pores in fluid communication with at least some of the interstitial spaces.

In an aspect, the hydrophilic nanoparticles can comprise oxide nanoparticles, the oxide nanoparticles optionally comprising any one or more of SiO₂, TiO₂, Al₂O₃, Fe₃O₄, Fe₂O₃, and CeO₂. SiO₂ and TiO₂ are considered particularly suitable, but other oxide nanoparticles can be used.

In an aspect, the solidified hydrophobic polymer can comprise any one or more of polyethylene (PE), polypropylene (PP), polyvinyl chloride (PVC), polystyrene (PS), poly(methyl methacrylate) (PMMA), polyethylene terephthalate (PET), and polydimethylsiloxane.

In an aspect, the hydrophilic nanoparticles have an average cross-sectional dimension in the range of from about 5 to about 100 nm. The cross-sectional dimension can be, for example from about 5 to about 100 nm, from about 10 to about 90 nm, from about 20 to about 80 nm, from about 30 to about 70 nm, from about 40 to about 60 nm, or even about 50 nm.

In an aspect, the hydrophilic nanoparticles can have an average cross-sectional dimension in the range of from about 25 to about 75 nm.

In an aspect, the heterostructured film has a thickness in the range of from about 100 nm to about 500 nm.

In an aspect, the heterostructured film has a thickness in the range of from about 100 nm to about 200 nm.

In an aspect, the solidified hydrophobic polymer defines a volume fraction (ϕ) of polymer within the heterostructured film, and wherein ϕ is less than 1.

In an aspect, ϕ is in the range of from about 0.01 to about 0.5.

In an aspect, ϕ is in the range of from about 0.01 to about 0.3.

In an aspect, ϕ is in the range of from about 0.1 to about 0.2.

In an aspect, the present disclosure provides a method, comprising exposing a heterostructured film according to any aspect herein to an atmosphere under such conditions that water from the atmosphere isothermally forms droplets on the porous surface of the heterostructured film.

In an aspect, the droplets are macroscopic.

In an aspect, the method further comprises collecting the droplets from the porous surface of the heterostructured film. Such collection can be accomplished manually, but can also be accomplished in an automated and/or passive fashion.

In an aspect, the collecting is performed continuously.

In an aspect, the collecting is performed in a batch manner.

In an aspect, capillary condensate fills the interstitial spaces of the heterostructured film completely and overflows as the droplets on the porous surface.

In an aspect, the present disclosure provides a method, comprising: contacting a heterostructured film according to any aspect herein to an atmosphere so as to effect isothermal recovery of water from the atmosphere.

In an aspect, the atmosphere has a humidity of at least 75%.

In an aspect, the atmosphere has a humidity of at least 90%.

What is claimed:

1. A heterostructured film configured to effect capillary condensation, the heterostructured film comprising:
a bed of hydrophilic nanoparticles,
the nanoparticles defining interstitial spaces therebetween; and
a solidified hydrophobic polymer,
the solidified hydrophobic polymer (i) bridging adjacent nanoparticles, (ii) partially filing some of the interstitial spaces between nanoparticles, or both (i) and (ii), and
the heterostructured film having a porous surface that defines pores in fluid communication with at least some of the interstitial spaces.

2. The heterostructured film of claim 1, wherein the hydrophilic nanoparticles comprise oxide nanoparticles, the oxide nanoparticles optionally comprising any one or more of SiO₂, TiO₂, Al₂O₃, Fe₃O₄, Fe₂O₃, and CeO₂.

3. The heterostructured film of claim 1, wherein the solidified hydrophobic polymer comprises any one or more of polyethylene (PE), polypropylene (PP), polyvinyl chloride (PVC), polystyrene (PS), poly(methyl methacrylate) (PMMA), polyethylene terephthalate (PET), and polydimethylsiloxane.

4. The heterostructured film of claim 1, wherein the hydrophilic nanoparticles have an average cross-sectional dimension in the range of from about 5 to about 100 nm.

5. The heterostructured film of claim 4, wherein the hydrophilic nanoparticles have an average cross-sectional dimension in the range of from about 25 to about 75 nm.

6. The heterostructured film of claim 1, wherein the heterostructured film has a thickness in the range of from about 100 nm to about 500 nm.

7. The heterostructured film of claim 6, wherein the heterostructured film has a thickness in the range of from about 100 nm to about 200 nm.

8. The heterostructured film of claim 1, wherein the solidified hydrophobic polymer defines a volume fraction (ϕ) of polymer within the heterostructured film, and wherein ϕ is less than 1.

9. The heterostructured film of claim 8, wherein ϕ is in the range of from about 0.01 to about 0.5.

10. The heterostructured film of claim 9, wherein ϕ is in the range of from about 0.01 to about 0.3.

11. The heterostructured film of claim 10, wherein ϕ is in the range of from about 0.1 to about 0.2.

12. A method, comprising exposing a heterostructured film according to claim 1 to an atmosphere under such conditions that water from the atmosphere isothermally forms droplets on the porous surface of the heterostructured film.

13. The method of claim 12, wherein the droplets are macroscopic.

14. The method of claim 12, further comprising collecting the droplets from the porous surface of the heterostructured film.

15. The method of claim 14, wherein the collecting is performed continuously.

16. The method of claim 15, wherein the collecting is performed in a batch manner.

17. The method of claim 12, wherein capillary condensate fills the interstitial spaces of the heterostructured film completely and overflows as the droplets on the porous surface.

18. A method, comprising: contacting a heterostructured film according to claim 1 to an atmosphere so as to effect isothermal recovery of water from the atmosphere.

19. The method of claim 18, wherein the atmosphere has a humidity of at least 75%.

20. The method of claim 19, wherein the atmosphere has a humidity of at least 90%.
